(19) United States
(12) Patent Application Publication
(10) Pub. No.: US 2008/0040032 A1
(43) Pub. Date: Feb. 14, 2008

(54) System for searching intersections and method thereof

(75) Inventor: Katsumi Ohashi, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/783,610

(22) Filed: Apr. 10, 2007

(30) Foreign Application Priority Data
Apr. 12, 2006 (JP) 2006-109546

(51) Int. Cl. G01C 21/26

(52) U.S. Cl. 701/209

(57) ABSTRACT

A system for searching an intersection according to a user's request is included in a navigation system mounted on an automotive vehicle. An intersection is searched from an intersection database stored in an on-board memory medium based on an intersection pattern designated by the user. The intersection pattern includes the number of branches included in an intersection and a shape of the intersection. To make the search more precise, the user may additionally input a location of the intersection and buildings located around the intersection, if those are known to the user. After the intersection search is completed, the intersection is shown on a display panel together with a map showing the vicinity of the intersection. According to the present invention, the desired intersection can be searched even if the name of the intersection is unknown to the user.

### CROSS-REFERENCE TO RELATED APPLICATION

This application is based upon and claims benefit of priority of Japanese Patent Application No. 2006-109546 filed on Apr. 12, 2006, the content of which is incorporated herein by reference.

### BACKGROUND OF THE INVENTION

1. Field of the Invention

The present invention relates to a system and a method for searching intersections, the system being mounted on an automotive vehicle.

2. Description of Related Art

An on-board system for searching intersections has been proposed hitherto. In this system, an intersection is searched from among intersections stored in a memory medium based on an intersection name inputted by a user. In this system, however, there is a problem that it is impossible to search an intersection if the user does not know the name of the intersection or if no name is given to that intersection.

Further, another system is proposed in JP-A-2002-366575. In this system, a search is conducted based on a query image designated by a user. This system, however, does not intend to search intersections, and therefore, it is difficult to utilize the system in searching intersections.

### SUMMARY OF THE INVENTION

The present invention has been made in view of the above-mentioned problem, and an object of the present invention is to provide an improved on-board system for searching intersections without inputting names of intersections.

The system for searching intersections is included in a navigation system mounted on an automotive vehicle. The searching system includes a memory medium storing an intersection database, switches for inputting user's request and a display panel for displaying images for the user's choice and search results. When a name of intersection is unknown to the user, the user inputs the number of branches included in an intersection to be searched. Then, the intersections having the designated number of branches are shown on the display panel, showing shapes of the intersections. The user selects one of the intersections having a particular shape that the user intends to search.

The system conducts a search for the intersection having the designated number of branches and the shape. Since the intersection database stores information regarding intersections classified according to their patterns including the number of branches and the shapes, the intersections having the designated pattern are displayed on the panel. The user selects one intersection from among displayed intersections. The name of the selected intersection is displayed on the display panel together with a map showing the vicinity of the intersection.

The user may additionally inputs a location (prefecture, city, village, etc.) of the intersection to be searched and buildings located in the vicinity of the intersection in order to make the search more precise. The searching system of the present invention may be formed separately from the navigation system.

According to the present invention, the intersection can be searched even if its name is unknown to the user. The searched intersection is shown on the display panel together with a map showing the vicinity of the intersection. The information regarding intersections can be retrieved from the intersection database stored in the on-board memory medium. Other objects and features of the present invention will become more readily apparent from a better understanding of the preferred embodiment described below with reference to the following drawings.

### BRIEF DESCRIPTION OF THE DRAWINGS

FIG. 1 is a block diagram showing an entire structure of a system for searching intersections;

FIGS. 2A-2C are schematic drawings showing exemplary shapes of intersections having four branches;

FIG. 3 is a flowchart showing a process for searching intersections;

FIG. 4A is an exemplary display showing the number of branches included in an intersection;

FIG. 4B is an exemplary display showing shapes of intersections each having four branches;

FIG. 5A is an exemplary display for designating a location of an intersection or buildings located in the vicinity of the intersection;

FIG. 5B is an exemplary display for designating a location of an intersection to be searched;

FIG. 5C is an exemplary display for designating buildings located in the vicinity of an intersection to be searched; and

FIG. 6 is an exemplary display showing search results.

### DETAILED DESCRIPTION OF THE PREFERRED EMBODIMENT

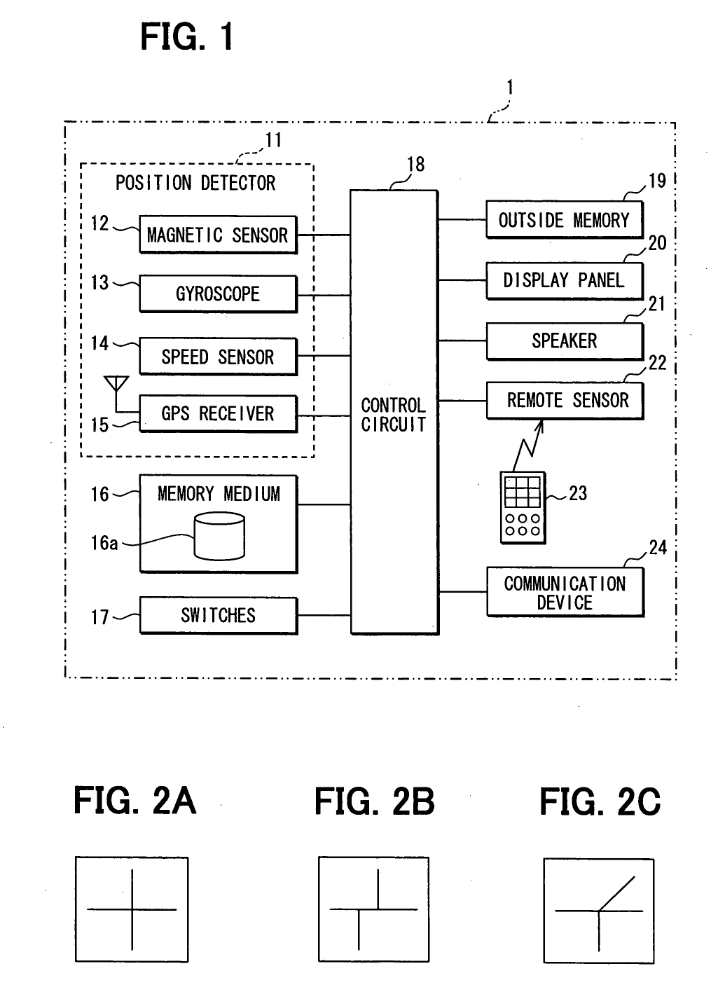

A preferred embodiment of the present invention will be described with reference to accompanying drawings. FIG. 1 shows an entire structure of a navigation system 1 mounted on an automotive vehicle. The navigation system 1 includes a position detector 11, a memory medium 16, a group of switches 17, a control circuit 18, an outside memory 19 (a memory provided outside of the control circuit 18), a display panel 20, a speaker 21, and a remote sensor 22. The control circuit 18 is connected to the components of the navigation system 1 and to a communication device 24 that performs communication with outside systems or devices.

The position detector 11 detects a position of the vehicle based on signals fed from various sensors, a magnetic sensor 12, a gyroscope 13, a vehicle speed sensor 14, and a GPS-receiver (a receiver for a global positioning system) 15. The memory medium 16 composed of memories such as a CD, a DVD and/or a HDD (a hard disk drive) stores various data including map data, map data for map-matching and road data. Various information necessary in the navigation system 1 is read out from the memory medium 16. The memory medium 16 further stores an intersection database 16a including positions of intersections (locations, latitudes, longitudes, etc.), names of intersections, and information concerning buildings located around intersections. The intersection database 16a is formulated by picking up places that can be served as intersections from an existing road database.

An intersection pattern including the number of branches in an intersection and a shape of an intersection is stored in the intersection database 16a for each intersection. FIGS. 2A-2C show examples of shapes of an intersection having four branches. The shapes of intersections having other numbers of branches (three, five, six, etc.) are all stored in the intersection data base 16a in a manner classified by the number of branches. The intersection shape shown in FIG. 2B may be classified in a group having four branches, or in a group having three branches (two intersections each having three branches. Such intersections as shown in FIG. 2B are classified in both groups, i.e., a group having four branches and a group having three branches. In this manner, all the intersections can be searched without being dropped out. In the information concerning buildings located around the intersections, those buildings are classified by genre, such as a city hall, a police station, a library, etc.

The switches 17 include mechanical button switches disposed around the display panel 20 and touch-sensitive switches formed on the display panel 20, overlapping displayed images. The user inputs various signals to the control circuit 18 through the switches 17. The outside memory 19 is a memory provided separately from an inside memory installed in the control circuit 18. The outside memory 19 composed of memory media such as a ROM or a RAM stores various data and programs therein. The display panel 20 is made of a liquid crystal display panel or the like and displays images thereon according to image signals fed from the control circuit 18.

Voices are outputted from the speaker 21 according to voice signals fed from the control circuit 18. The remote sensor 22 receives wireless signals such as infrared signals from the remote controller 23 and feeds the received signals to the control circuit 18. The communication device 24 wirelessly communicates with outside devices and feeds the received signals to the control circuit 18. The control circuit 18 includes a computer having a CPU and memories. The CPU in the control circuit 18 performs various processes according to programs stored in the memories.

The processes performed by the control circuit 18 include: a process for calculating a present position of the vehicle based on signals fed from the position detector 11; a process for displaying a map on the display panel together with a mark showing the present position of the vehicle; processes for searching facilities, telephone numbers, addresses or intersections according to user's requests; a process for searching a route to a destination; and a process for guiding a driver to the destination.

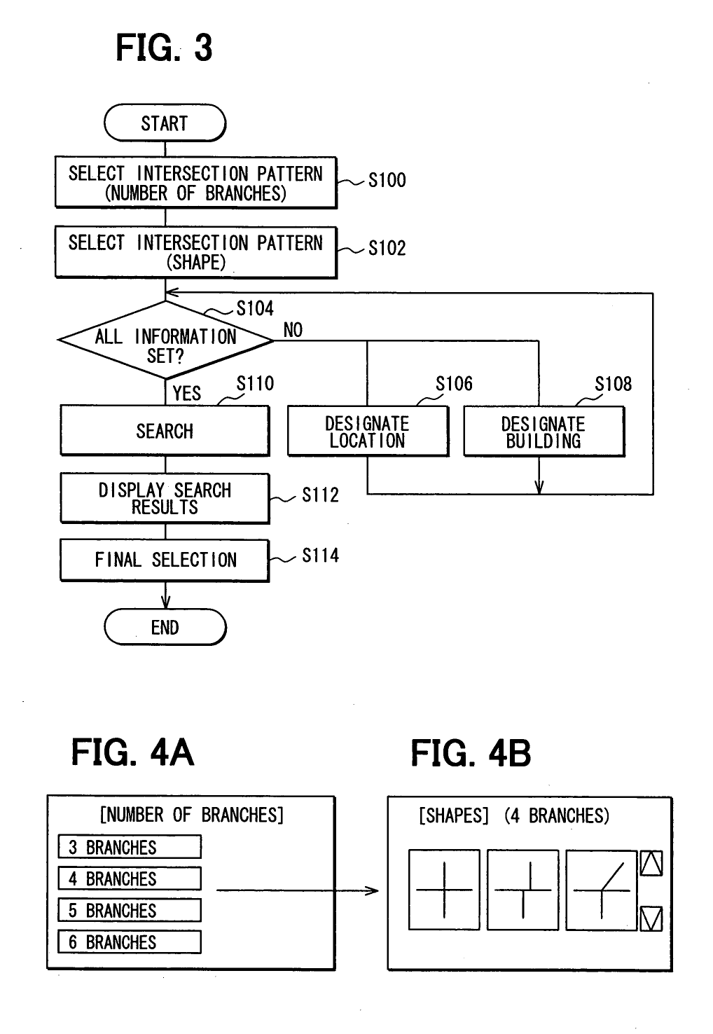

Upon turning on an ignition switch of the vehicle, the navigation system 1 is put into operation, the control circuit 18 initiates various processes such as the process for calculating the present position and the process for displaying a map on the display panel 20. When the user inputs a request for searching an intersection through the switches 17, the control circuit 18 starts the process of searching an intersection, which will be described in detail with reference to a flowchart shown in FIG. 3.

At steps S100 and S102, an intersection pattern is selected by the user. More specifically, at step S100, an image showing the number of branches included in an intersection (FIG. 4A) is displayed on the display panel 20. The user selects the number of branches included in the intersection which he/she wants to search. Then, at step S102, an image showing shapes of intersections (FIG. 4B) is displayed on the display panel 20. In this particular example shown in FIG. 4B, it is assumed that the user selected intersections each having four branches. The user selects one of the intersections that has a shape he/she wants from among the displayed shapes. If there is no desired shape on the displayed image, the user can add some more shapes by using scroll bar on the image.

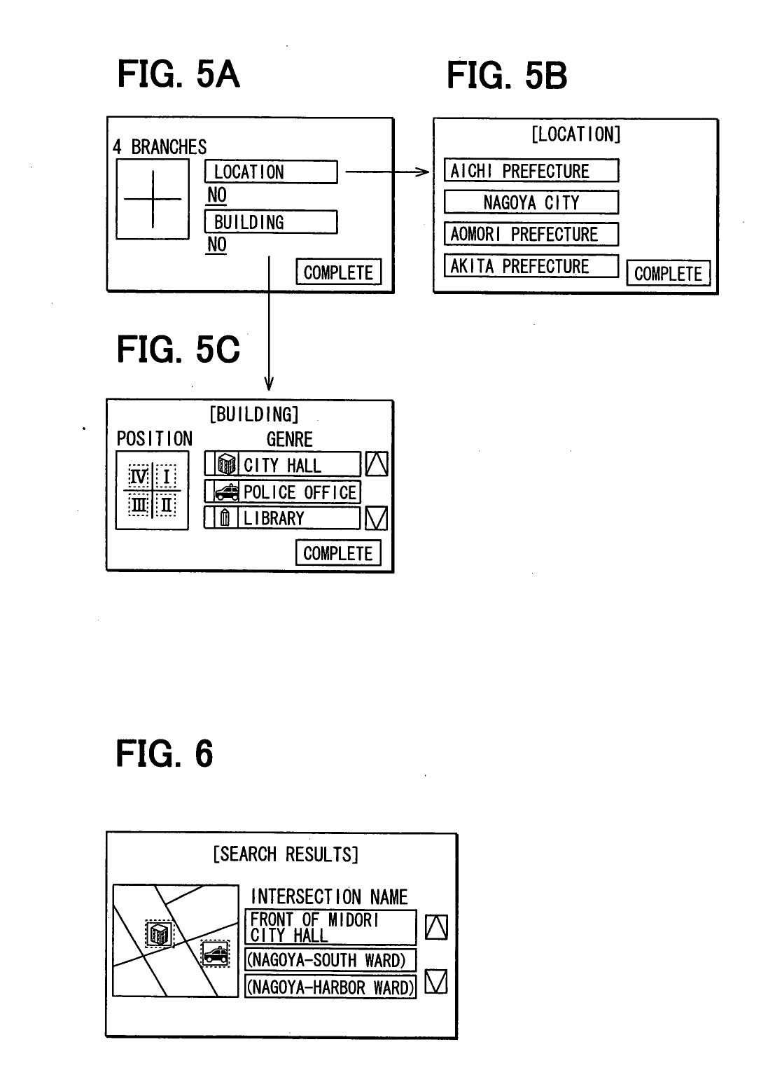

At step S104, whether all the information for searching an intersection are inputted is determined. If some other information, i.e., a location of the intersection and/or buildings located around the intersection, are necessary, the process proceeds to steps S106 and S108 according to the user's intention. When the additional information is required, an image shown in FIG. 5A is displayed. According to the displayed image, the user can designate the location of the intersection at step S106 and/or buildings located around the intersection at step S108. If it is determined that all the information is set at step S104, the process proceeds to the next step S110.

If the user touches a button (in FIG. 5A) for designating the location of the intersection, the process proceeds to step S106. At step S106, an image shown in FIG. 5B is displayed, so that the user designates the location of the intersection to be searched. For example, a prefecture, a city and a village where the intersection is located can be designated in a hierarchy order. Upon completion of the location-designation, the user touches the “complete” button to return to the former image shown in FIG. 5A.

If the user touches a button for designating the nearby-buildings on the image shown in FIG. 5A, the process proceeds to step S108. At step S108, an image shown in FIG. 5C is displayed, so that the user can designate buildings located in the vicinity of the intersection to be searched. As shown in FIG. 5C, the buildings are classified by “genre”, such as CITY HALL, POLICE OFFICE, LIBRARY, etc. Additional genre may be displayed by touching a scroll bar. A map showing four sections around the intersection is also displayed (FIG. 5C). For example, the area around the intersection is divided into four sections, I, II, III and IV. The map may be shown by placing the north direction upward, for example. The user designates “genre” of the building together with a section where the building is located. When the designation of the nearby-building is completed, the user touches a “complete” button to thereby return to the previous step S104.

At step S104, the image shown in FIG. 5A is displayed again. Upon touching the “complete” button, the process proceeds to the next step S110. The designation of the location of the intersection and the nearby-building is not mandatory. If the user determines such designation is not necessary, the user may touch the “complete” button without going to steps S106 and S108. At step S110, the intersection is searched from the intersection database 16a according to the information inputted by the user. More specifically, if no information regarding the location and the nearby-building of the intersection is not inputted by the user, the intersection is searched based on the information as to the number of branches (inputted at step S100) and the shape (inputted at step S102) of the intersection. If all the information including the location and the nearby-building are inputted, the intersection is searched based on all of the information.

Then, the process proceeds to step S112, where the search results are displayed on the display panel 20. More specifically, plural intersections that satisfy all the conditions inputted are listed by their names, or by locations if the intersections have no names. In an exemplary image shown in FIG. 6, a name or a location of each intersection is displayed together with a map showing the first intersection listed. Additional intersections may be displayed by touching a scroll bar. When the user selects an intersection from the list, the map of the selected intersection is displayed on the display panel 20. It is also possible to set an intersection thus selected as a destination or a point of passing-through in a driving route.

Advantages of the present invention will be summarized below. Since the intersection is searched based on the intersection pattern including the number of branches and the shape of the intersection, the intersection desired by the user can be searched without inputting the name of the intersection. (The intersection database 16a stores the intersections in a manner classified by the number of branches and the shapes.) Since the intersection database 16a is on-board and read out by the on-board device, it is not necessary to communicate with outside devices to obtain the information of the intersections. Therefore, the intersections can be searched even when wireless communication is not in good conditions.

The desired intersection can be searched according the number of branches and its shapes inputted by the user. Further, the user may input additional information including the location and the nearby-buildings of the intersection to make the search more precise. A map of an intersection selected by the user from the listed intersections can be displayed on the display panel 20.

The present invention is not limited to the embodiment described above, but it may be variously modified. For example, it is possible to store the intersection database 16a in a server of a fixed station and to search an intersection desired by the user via wireless communication through the communication device 24. Though the search of the intersection is conducted based on the number of branches and the shapes of the intersection in the foregoing embodiment, it is possible to conduct the search based on only the intersection shapes. Though the search of the intersections is conducted in the navigation system 1, the search system may be formed separately from the navigation system.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A system, mounted on an automotive vehicle, for searching intersections, the system comprising:
means for selecting patterns of intersections according to a user's request;
means for searching intersections corresponding to the selected patterns from an intersection database stored in a memory medium; and
means for displaying information regarding the intersections searched.

2. The searching system as in claim 1, further including means for retrieving the information regarding the intersections from the memory medium.

3. The searching system as in claim 1, wherein:
the selecting means displays a plurality of intersection patterns from which the user chooses one.

4. The searching system as in claim 1, wherein:
the selecting means displays the intersection patterns classified according to the number of branches included in an intersection.

5. The searching system as in claim 1, wherein:
the memory medium also stores map data; and
the display means displays the searched intersection together with a map showing the vicinity of the intersection.

6. The searching system as in claim 1, wherein:
the selecting means further includes means for designating a location of the intersection; and
the searching means searches the intersections having the selected pattern and being located at the designated location.

7. The searching system as in claim 1, wherein:
the memory medium includes information regarding buildings located in the vicinity of the intersections; and
searching means searches the intersections having the selected pattern, in the vicinity of which a building designated by the user is located.

8. A method of searching an intersection, comprising:
selecting an intersection having an intersection pattern designated by a user;
searching the selected intersection from a database stored in a memory medium; and
displaying the searched intersection on a display panel.

9. The method as in claim 8, wherein:
the intersection pattern includes the number of branches included in an intersection and a shape of the intersection.
